(19) United States
(12) Patent Application Publication
(10) Pub. No.: US 2010/0246905 A1
(43) Pub. Date: Sep. 30, 2010

(54) PERSON IDENTIFYING APPARATUS, PROGRAM THEREFOR, AND METHOD THEREOF

(75) Inventors: Mayumi Yuasa, Tokyo (JP); Yamada Miki, Kanagawa (JP); Osamu Yamaguchi, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/561,437

(22) Filed: Sep. 17, 2009

(30) Foreign Application Priority Data
Mar. 26, 2009 (JP) 2009-076367

(51) Int. Cl. G06K 9/00

(52) U.S. Cl. 382/118

(57) ABSTRACT

A person identifying apparatus calculates suitability as a reference for improving a face identification rate of an identical person appeared in frames of a moving image on the frame-to-frame basis, selects a frame from the moving image using the suitability, calculates a feature value from the selected frame, and identifies the face of the person on the basis of a similarity between the feature value and a feature value of a reference frame selected in advance using the suitability.

### CROSS-REFERENCE TO RELATED APPLICATION

This application is based upon and claims the benefit of priority from the prior Japanese Patent Application No. 2009-76367, filed on Mar. 26, 2009; the entire contents of which are incorporated herein by reference.

### FIELD OF THE INVENTION

The present invention relates to a person identifying technology for identifying persons' faces.

### DESCRIPTION OF THE BACKGROUND

In the related art, as disclosed in JP-A-2005-227957 (KOKAI), there are methods of selecting a best shot, which is a method of selecting an image that is thought to be a best shot by a person from a moving image of a face, and a method of storing the selected best shot.

However, with the technology disclosed in JP-A-2005-227957, since the selection is made from a view point whether the face is easily visible or not, such as whether the face is oriented toward the front or the brightness of a surface of the face, the selected image is not necessarily suitable for a face identification.

As disclosed in JP-A-2005-141437 (KOKAI), there is a method of identifying a face using the moving image. However, with the technology disclosed in JP-A-2005-141437, there is a case where the performance of identification is lowered if an image which is significantly different from a registered reference data in terms of the state of the face such as the pose is included at the time of identification.

As described above, the technology in the related art has problems such that since the selection of the image is made from the view point whether the face is easily visible or not, such as whether the face is oriented toward the front or the brightness of the surface of the face, the selected image is not necessarily suitable for the face identification.

In order to solve the above-described problems, it is an object of the invention to provide a person identifying apparatus which achieves an improved face identification rate, a program therefor, and a method thereof.

### SUMMARY OF THE INVENTION

According to embodiments of the invention, there is provided a person identifying apparatus including a selecting unit configured to calculate suitability as a reference for improving a face identification rate of an identical person appeared in frames of a moving image on the frame-to-frame basis and select a frame from the moving image using the suitability; and a identifying unit configured to calculate a feature value from the selected frame and identify the face of the person on the basis of a similarity between the feature value and a feature value of a reference frame selected in advance using the suitability.

According to the embodiments of the invention, improvement of the face identification rate is achieved by selecting a frame suitable for the face identification from the moving image.

### BRIEF DESCRIPTION OF THE DRAWINGS

FIG. 1 is a block diagram showing a configuration of a person identifying apparatus according to an embodiment of the invention;

FIG. 2 is a flowchart showing an operation of the person identifying apparatus;

FIG. 3 is an example of a face feature point;

FIG. 4 is a first explanatory drawing showing a state of usage of the person identifying apparatus;

FIG. 5 is a drawing of a moving image of a face shot by a camera in the state of usage in FIG. 4;

FIG. 6 is a second explanatory drawing showing the state of usage of the person identifying apparatus; and

FIG. 7 is a drawing of a moving image of a face shot by a camera in the state of usage in FIG. 6.

### DETAILED DESCRIPTION OF THE INVENTION

Referring now to FIG. 1 to FIG. 7, a person identifying apparatus 10 according to a first embodiment of the invention will be described.

The person identifying apparatus 10 in the embodiment includes a camera 2 installed in a path 1 or the like as shown in FIG. 4 and FIG. 6, and aims to identify a face of an identical person to be identified (hereinafter, referred to simply as “person”) 3 passing through the path 1.

FIG. 1 is a block diagram showing the person identifying apparatus 10 according to the embodiment of the invention.

As shown in FIG. 1, the person identifying apparatus 10 includes a detecting unit 12, an estimating unit 14, a selecting unit 16, a registering unit 18, an identifying unit 20, and a storage unit 22.

The detecting unit 12 detects a face feature point of the person 3 from respective frames of a moving image inputted from the camera 2.

The estimating unit 14 estimates a face angle which indicates the direction of orientation of the face of the person 3 from respective coordinates of the face feature points of the respective frames.

The selecting unit 16 selects frames from the moving image using suitability as a reference for improving a face identification rate.

The registering unit 18 uses the suitability to register a feature value of a reference frame selected in advance in the storage unit 22.

The identifying unit 20 identifies the face of the person 3 by comparing the feature value registered in the storage unit 22 and feature values generated from the respective frames selected by the selecting unit 16.

The person identifying apparatus 10 may also be realized by using a general-purpose computer as basic hardware. In other words, the detecting unit 12, the estimating unit 14, the selecting unit 16, the registering unit 18, and the identifying unit 20 may be realized by causing a processor mounted on the computer to execute a program. At this time, the person identifying apparatus 10 may be realized by installing the program in the computer in advance, or may be realized by storing the same in a storage medium such as a CD-ROM or by distributing the program via a network and installing the program in the computer as needed.

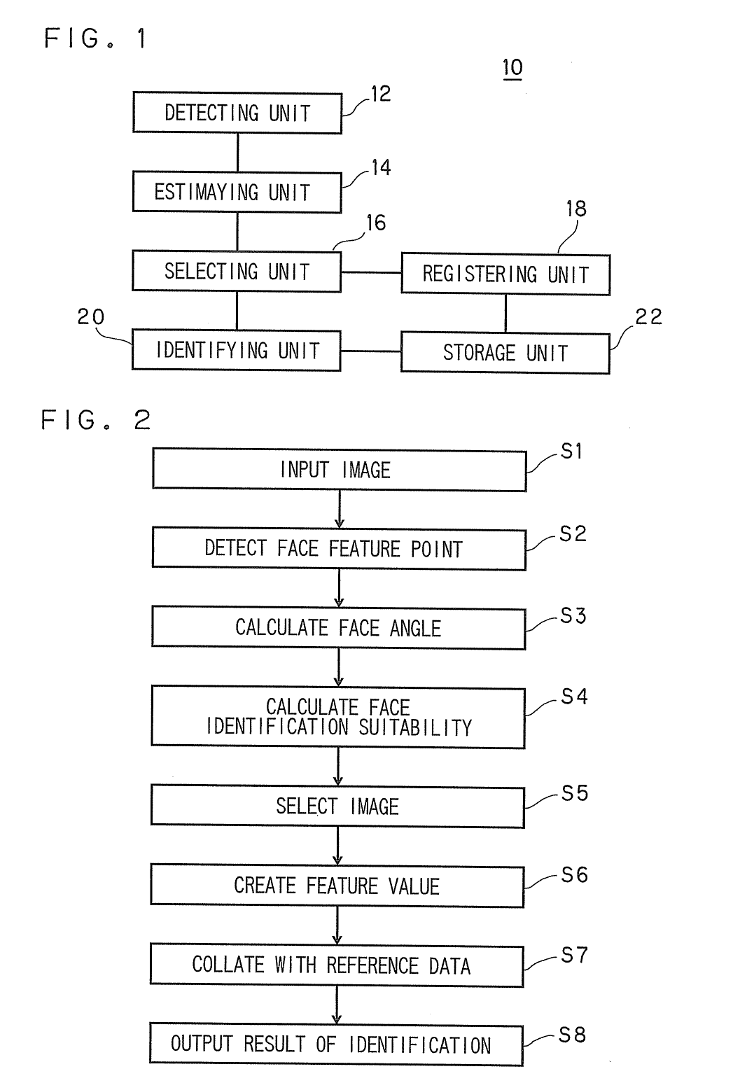

Referring now to FIG. 2, an operation of the person identifying apparatus 10 will be described. FIG. 2 is a flowchart showing the operation of the person identifying apparatus 10.

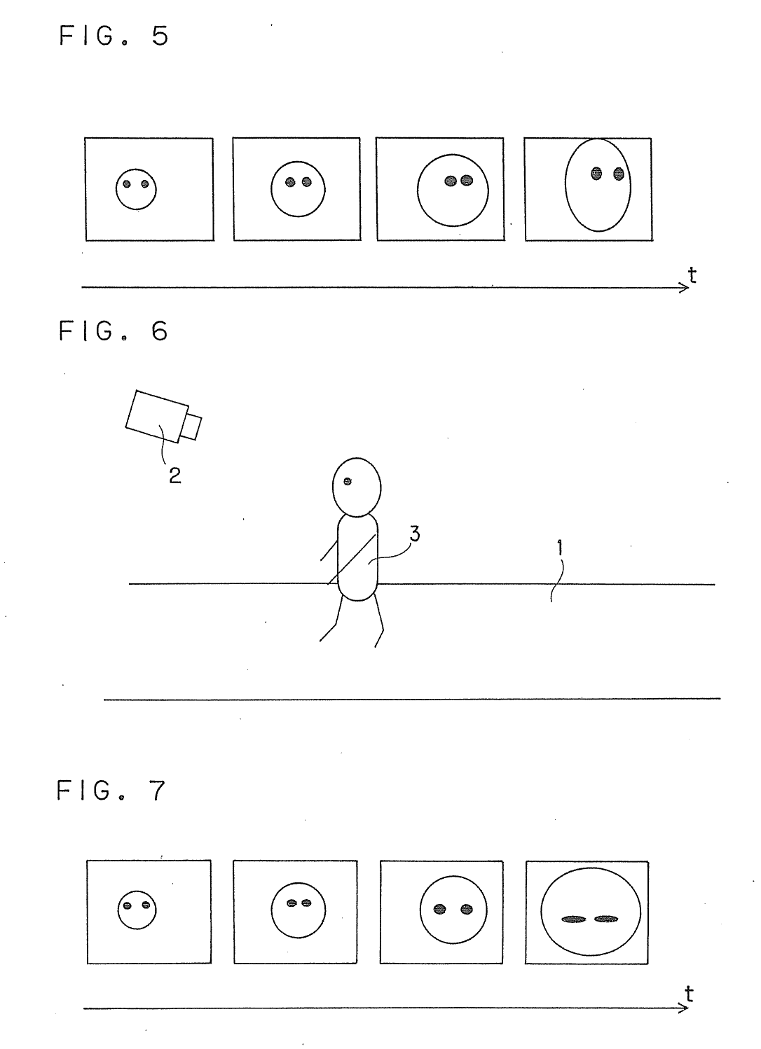

In Step S1, the person identifying apparatus 10 inputs a moving image from the camera 2 installed in the path 1. For example, in an example shown in FIG. 4, the camera 2 is installed on one of side walls of the path 1 at a position which is the same level as the level of the face of the person 3. FIG. 5 shows the respective frames of the moving image in which the face of the person 3 shot by the camera 2 appears arranged in an order of a time series t. In an example shown in FIG. 6, the camera 2 is installed so as to look down from a ceiling of the path 1, and FIG. 7 shows the respective frames of the moving image in which the face of the person 3 shot by the camera 2 appears arranged in the order of the time series t.

In Step S2, the detecting unit 12 detects a plurality of the face feature points in each of the frames of the inputted moving image. For example, a method as disclosed in Japanese Patent No. 3279913 may be employed. More specifically, the method is as follows.

First of all, feature point candidates are detected by a separability filter for one frame.

Subsequently, a feature point set is selected by evaluating a feature point arrangement when the feature point candidates are combined.

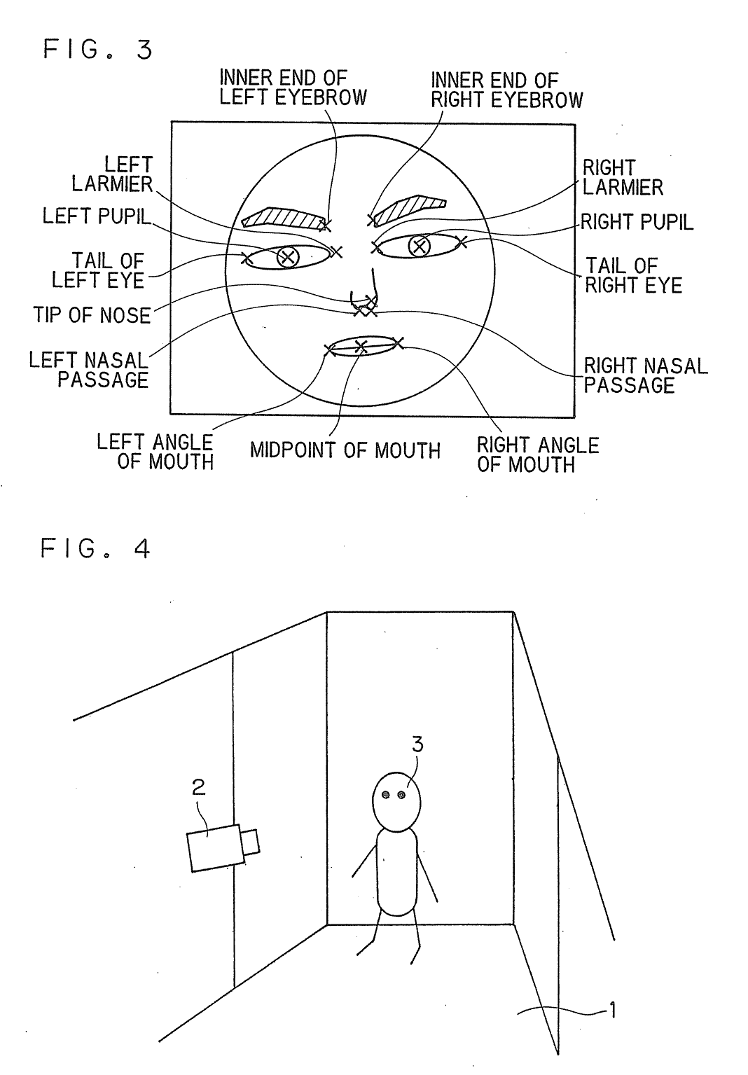

Subsequently, the face feature points are detected by performing a template matching of a partial area of the face. As kinds of the face feature points, for example, as shown in FIG. 3, fourteen points; an inner corner of a right eyebrow, an inner corner of a left eyebrow, an inner corner of a right eye, an inner corner of a left eye, a right pupil, a left pupil, an outer corner of a right eye, an outer corner of a left eye, a tip of a nose, a right nostril, a left nostril, a right corner of a mouth, and a left corner of the mouth, and a center point of the mouth are used.

In Step S3, the estimating unit 14 calculates the face angle of the person 3 using the coordinates of the plurality of the face feature points for each frame obtained by the detecting unit 12. For example, a method of calculating the face angle from positional coordinates of the feature points disclosed in JP-A-2003-141551. More specifically, the method is as follows.

First of all, a camera motion matrix is calculated by multiplying a measurement matrix including two-dimensional coordinates of the face feature points in the frame by a pseudo inverse matrix of a shape matrix indicating a three-dimensional shape of a face shape. Here, the three-dimensional shape may be obtained from the frame using a factorization method, or a generic face shape as a generic shape model prepared in advance may be used. The factorization method is disclosed in C. Tomasi and T. Kanade, “Shape and motion from image streams under orthography; a factorization method,” International Journal of Computer Vision, vol. 9, no. 2, pp. 137-154, 1992. In this embodiment, the generic face shape is used.

Subsequently, the face angle is obtained from the camera motion matrix. The camera motion matrix corresponds to a rotation matrix if a scale is eliminated, and if the rotation matrix is apparent, rotations in three directions are obtained. However, the camera motion matrix is a matrix of 3×2, and in order to obtain the rotation matrix of 3×3, a supplement of the rotation matrix is required.

The rotation matrix is expressed by a square matrix of 3×3, and hence has nine components. However, degree of freedom is 3, and if part of the components is given, the remaining components might be obtained uniquely, and in that case, all of the components may be obtained from an elementary calculation. When six components in upper two rows of the rotation matrix are given with errors contained therein, a complete rotation matrix is obtained by supplementing three components of a remaining lowermost row in a following process.

First of all, row vectors of the first and second rows are corrected so that their norms become 1 without changing the respective directions.

Secondly, only the directions are corrected without changing the lengths of the respective vectors so that an inner product of the row vector of the first row and the row vector of the second row becomes zero. At this time, the correction is made without changing the direction of an average vector of the two vectors.

Thirdly, using the six components in the upper two rows, a quaternion equivalent to the rotation matrix is calculated.

A relational expression between the rotation matrix and the quaternion is described, for example, in p. 22, in “Three-Dimensional Vision” (Takeshi JO, Saburo TUJI, Kyoritsu Shuppan Co., Ltd.: 1998), and the quaternion can be obtained by the elementary calculation using the relational expression.

Fourthly, the components in the lowermost row of the rotation matrix are calculated from the obtained quaternion using the relational expression between the rotation matrix and the quaternion again.

When the rotation matrix of 3×3 is obtained in this manner, the face angle including three directions of vertical (yaw), lateral (roll), and tilting (pitch) as three-axes rotation angles can be obtained.

In Step S4, the selecting unit 16 calculates the suitability from the face angle. The face angle is obtained by decomposing into three directions; the vertical, lateral, and tilting directions as described above. Therefore, these are defined as an upward angle θ₁, a rightward angle θ₂, and a tilting angle θ₃. When a given three-dimensional rotational angle is obtained, these angles are obtained by transformation as needed. From these angles, suitability S_{d} expressed by an expression (1) is calculated. The suitability is a reference to improve the face identification rate, that is, a reference when selecting a frame from the moving image for improving the face identification rate. Therefore, the higher the suitability, the more the identification rate is improved. Then, the suitability S_{d} is set to be maximum when the face is oriented to the front with respect to the camera 2.

S_{d}=−\sqrt{θ₁²+θ₂²} (1)

In this manner, the suitability in which the angle other than the rotation in the frame is close to the front can be selected by using the upward angle and the rightward angle excluding the tilting angle. Normally, the identification rate is not much affected by the rotation in the frame, but the identifying performance is lowered with increase of the upward angle and the rightward angle which is directions to move away from the frame. Therefore, by using this suitability, the frame suitable of identification can be selected.

Subsequently, the selecting unit 16 selects frames used for the identification of the face using the suitability of the moving image calculated on the frame-to-frame basis. This selection selects a given number of frames from the moving image sequentially in a descending order in suitability.

In Step S5, the identifying unit 20 determines whether the person 3 is a registered person by obtaining a similarity between the feature values generated from the frames selected as described above and the feature value of the reference frame stored in the storage unit 22 using Orthogonal Mutual Subspace Method which allows comparison between the moving images.

The identifying unit 20 extracts the feature values for identifying the face for the plurality of frames selected on the basis of the suitability as described above. The method is performed as follows.

First of all, the orientation of the face is normalized to the front by coordinating feature point coordinates obtained by the detecting unit 12 and a three-dimensional generic face shape model for each of the frames. Then, an illumination normalization which extracts a ratio of a diffuse reflection factor which is not affected by lighting conditions is applied. Subsequently, KL expansion is performed for the selected plurality of frames to leave a high-order dimension, so that a subspace is generated. This subspace corresponds to the feature value.

The identifying unit 20 calculates the similarity between the feature values of the selected frames and the feature value of the reference frame registered in the storage unit 22 by the registering unit 18, and determines whether the face of the person 3 is the face of the registered person or not.

The reference frame registered in the storage unit 22 is prepared in advance. In other words, the suitability is calculated for the moving image shot by the camera 2 including the face of the person to be registered appeared therein on the frame-to-frame basis as described above using the detecting unit 12, the estimating unit 14, and the selecting unit 16. Subsequently, the identifying unit 20 calculates the feature values for the plurality of frames having the high suitability. Then, the registering unit 18 registers the feature values on the frame-to-frame basis.

According to the embodiments of the invention, improvement of the face identification rate is achieved by selecting a frame suitable for the face identification from the moving image.

### (Modifications)

The invention is not limited to the embodiments shown above as is, and components may be modified and embodied without departing from the scope of the invention in the stage of implementation. Various modes of the invention are achieved by combining the plurality of components disclosed in the embodiments described above as needed. For example, several components may be eliminated from all the components shown in the embodiment. In addition, the components in different embodiments may be combined as needed.

For example, there are modifications as shown below.

When selecting the frames in the above-described embodiment, the given number of frames is selected in sequence in the descending order in the suitability. However, the invention is not limited thereto. For example, a given ratio of the frames may be selected or, alternatively, the frames in a given range may be selected. Also, the frames may be selected under the conditions of the angle before calculating the suitability. For example, a method of selecting the frames in which the upward angle and rightward angle of the face fall within a range from +15 degrees to −15 degrees may also be employed.

Although the suitability is set to be maximum when the face faces the front with respect to the camera in the above-described embodiment, an arbitrary orientation is also applicable. For example, the suitability may be set to be maximum when it is close to a representative value of the face angle when the reference frame is registered. Also, it is also possible to classify face images by selecting the same in a plurality of methods when registering the reference frame, and identify the face using the data of a class which includes a largest number of selected input images on the basis of respective selection references. Also, it is also possible to obtain a result of determination by performing the identification for the respective classes, and combining the similarities.

Although the suitability is calculated from the face angle, the invention is not limited thereto, and may be a given number calculated from the image of the face feature points.

Although the suitability is defined to be a value to be calculated by the expression (1) in the above-described embodiment, the invention is not limited thereto, and it must simply be an evaluation value which is increased as the angle excluding the tilting angle is reduced from the front faced angle. A given value calculated from the face angle other than those described above is also applicable.

Although the suitability employs only the face angle in the embodiment described above, the invention is not limited thereto. For example, a size of the face, a resolution, a time, or a distance from the camera may be employed, and also a combination thereof may also be applied. For example, in the case of the person who approaches the camera, it is considered that the size of the face is increased as the time elapses, the suitability S_{d+t} in which the face angle and the time are considered may be calculated by;

S_{d+t}=−\sqrt{θ₁²+θ₂²}+c(t−t₀) (2)

using time t, where, c is a predetermined constant, and t0 is a starting time of the moving image.

Although the face angle is calculated from the face feature points in the embodiment described above, the invention is not limited thereto, and the face angle may be obtained by pattern recognition by placing a template on the face image.

What is claimed is:

1. A person identifying apparatus comprising:
a selecting unit configured to calculate a suitability as a reference for improving a face identification rate of an identical person appeared in frames of a moving image on the frame-to-frame basis and select a frame from the moving image using the suitability; and
an identifying unit configured to calculate a feature value from the selected frame and identify the face of the person on the basis of a similarity between the feature value and a feature value of a reference frame selected in advance using the suitability.

2. The apparatus according to claim 1, further comprising an estimating unit configured to estimate a face angle of the person from the frames, wherein the selecting unit calculates the suitability from the face angle.

3. The apparatus according to claim 2, wherein the face angle estimated by the estimating unit includes an upward angle, a rightward angle, and a tilting angle of the face, and the selecting unit calculates the suitability using the upward angle and the rightward angle.

4. The apparatus according to claim 2, further comprising a detecting unit configured to detect a face feature point of the face of the person on the frame-to-frame basis, wherein the estimating unit estimates the face angle from the face feature point.

5. The apparatus according to claim 4, wherein the estimating unit obtains a camera motion matrix by multiplying a measurement matrix including coordinates of the face feature points by a pseudo inverse matrix of a shape matrix which represents a face shape, and calculates the face angle using the camera motion matrix.

6. The apparatus according to claim 1, further including a detecting unit configured to detect the face feature point of the face of the person on the frame-to-frame basis, wherein the selecting unit calculates the suitability from the coordinates of the face feature point.

7. A person identifying program stored in a computer readable media, the program causing a computer to realize the instructions of:
calculating suitability as a reference for improving a face identification rate of an identical person appeared in frames of a moving image on the frame-to-frame basis and selecting a frame from the moving image using the suitability; and
calculating a feature value from the selected frame and identifying the face of the person on the basis of a similarity between the feature value and a feature value of a reference frame selected in advance using the suitability.

8. A person identifying method comprising:
calculating suitability as a reference for improving a face identification rate of an identical person appeared in frames of a moving image on the frame-to-frame basis and selecting a frame from the moving image using the suitability; and
calculating a feature value from the selected frame and identifying the face of the person on the basis of a similarity between the feature value and a feature value of a reference frame selected in advance using the suitability.
